(19) United States
(12) Patent Application Publication
(10) Pub. No.: US 2008/0208623 A1
(43) Pub. Date: Aug. 28, 2008

(54) SYSTEM AND METHOD FOR DETERMINING AND DISPLAYING ACUITY LEVELS FOR PATIENTS

(75) Inventors: Nancy Fahey, Parkville, MO (US); Cheryl Hertel, Blue Springs, MO (US)

Correspondence Address: SHOOK, HARDY & BACON L.L.P.;Intellectual Property Department, 2555 GRAND BOULEVARD, KANSAS CITY, MO, 64108-2613, US

(73) Assignee: CERNER INNOVATION, INC., Overland Park, KS (US)

(21) Appl. No.: 11/739,870

(22) Filed: Apr. 25, 2007

Related U.S. Application Data
(60) Provisional application No. 60/891,337, filed on Feb. 23, 2007.

(51) Int. Cl. G06Q 50/00

(52) U.S. Cl. 705/2

(57) ABSTRACT

A system and method for calculating and displaying an acuity level for a patient is provided. A single indication from a user specifying a care needs assessment for a patient is received. A single indication from a user specifying an assessment of activities of daily living for the patient is received. The care needs assessment indication and the activities of daily living assessment indication are utilized to calculate an acuity level for the patient. The calculated acuity level for the patient is presented to one or more caregivers.

### CROSS-REFERENCE TO RELATED APPLICATIONS

This application claims the benefit of priority of U.S. Provisional Application Ser. No. 60/891,337 filed on Feb. 23, 2007.

### STATEMENT REGARDING FEDERALLY SPONSORED RESEARCH OR DEVELOPMENT

Not applicable.

### BACKGROUND

Healthcare organizations must identify whether they have staff capacity to deliver an appropriate level of care based on the needs of a given patient population. These organizations are also required to demonstrate that they are staffed properly under governmental rules. However, healthcare organizations trail other industries in the quality and efficiency of their management of workforce and production issues.

Traditionally, workforce management in the healthcare industry has been remarkably reactionary. For instance, a nurse manager will mentally calculate the number of workers needed for their unit based on the number of patients in the unit and will shift personnel based on these calculations. This method of workforce management is ineffective and time consuming, and oftentimes fails since an appropriate accounting for the acuity of the patient population is not factored into the calculations or management decisions.

Current acuity systems were developed in the late 1960's and 1970's. These systems are time intensive for a clinician to complete, do not encourage professional judgment and fail to encompass the complexities of nursing care. Acuity systems for determining patient classification or workload for a patient population include the VanSlyck methodology and the GRASP methodology. The VanSlyck methodology is “‘factor-based’” and classifies types of patients within one of seven levels of acuity based on activity studies performed for the organization. The patient classification levels relate to the number of hours of nursing care required to treat the patient based on the activity studies performed for the organization. The GRASP methodology, a “‘time-intervention’” model, assigns relative value units (RVUs) to different tasks performed for the patient. For instance, starting an IV for a patient may be assigned a relative value unit of 1, indicating 1/10 of an hour of time is required to perform the task. The RVUs are aggregated to assist in making workforce management decisions.

However, these methodologies are time-consuming and may not accurately capture the acuity level of a patient in a clinical care setting. Also, these methodologies do not capture the data during the planning and documenting of care in the primary clinical information system and are thus prone to error.

No leading acuity system has emerged. Furthermore, existing methodologies require redesign to interoperate with a patient's electronic medical record. For these and other reasons, many healthcare facilities have chosen not to use an acuity system.

### SUMMARY

In one embodiment, a computer-readable medium having computer-executable instructions for performing steps to calculate and display an acuity level for a patient is provided. A single indication from a user specifying a care needs assessment for a patient is received. A single indication from a user specifying an activities of daily living assessment for the patient is received. The care needs assessment indication and the activities of daily living assessment indication are utilized to calculate an acuity level for the patient. The calculated acuity level for the patient is presented to one or more caregivers.

In another embodiment, a graphical user interface embodied on a computer-readable medium and executable on a computer is provided. The graphical user interface comprises a first display area configured for displaying two or more care needs assessment options for a patient and a second display area configured for displaying two or more activities of daily living needs assessment options for the patient. A user may select one of the care needs assessment options and one of the activities of daily living needs assessment options to be utilized to calculate an acuity level for a patient.

In yet another embodiment, in a computer system having a graphical user interface including a display and a user interface selection device, a method of calculating and presenting an acuity level for a patient is provided. A single indication is received from a user utilizing a user interface selection device to specify a care needs assessment for a patient. A single indication is received from a user utilizing a user interface selection device to specify an activities of daily living assessment for the patient. An acuity level for the patient is calculated based on the care needs assessment indication and the activities of daily living assessment indication. The calculated acuity level for the patient is presented to one or more caregivers.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing embodiments of the present invention;

FIG. 2 is a block diagram of an acuity calculator and scheduling system in accordance with embodiments of the present invention;

FIG. 3 is a flow diagram of a method for calculating an acuity level for a healthcare patient in accordance with an embodiment of the present invention;

FIG. 4 is a graphical display of a questionnaire displayed to a nurse for the input of a patient's care needs intensity assessment and an activities of daily living dependence assessment in accordance with an embodiment of the present invention;

FIG. 5 is a graphical display of elements that may be taken into account when determining the care needs intensity of a patient in accordance with an embodiment of the present invention;

FIG. 6 is a graphical display of the acuity score determined for a patient in accordance with an embodiment of the present invention;

FIG. 7 is a graphical display of a staffing needs calculator in accordance with an embodiment of the present invention; and

FIG. 8 is a graphical display of a patient access list displaying calculated acuity levels for patients in accordance with an embodiment of the present invention.

### DETAILED DESCRIPTION

Systems and methods for determining acuity levels for patients are provided. A professional judgment acuity methodology for classifying patients according to their care level and dependency is described. Utilizing the patient's care level and dependency level classifications, an acuity level for the patient is determined. Methods for displaying the calculated acuity levels for patients are also is provided.

The acuity determination system provided may be integrated into a clinician's workflow, such as in an electronic medical record (or other computerized patient documentation) in an integrated healthcare information technology system. Acuity systems measure the severity of illness for given patient or patient population and assess patient care requirements against standard measures. The acuity system of the present application utilizes professional nursing judgment to help determine an acuity level for a patient. As such, the acuity system accurately captures patient care need complexity and is not cost prohibitive to implement and maintain. Furthermore, the acuity system allows healthcare organizations to easily respond to legislation at a state or federal level regarding staffing levels in relation to the acuity levels of the relevant patient populations. Acuity levels may be utilized to help determine appropriate staffing and create patient nursing assignments. Acuity levels of patients can be also used to determine appropriate staffing, create patient assignments, trend patient care needs and create unit budgets. The acuity levels of patients can be used prospectively and retrospectively for staffing determinations.

The acuity levels may also be used for reimbursement and patient room charges. Costs for patient care may be leveled based on patient acuity levels. The acuity system may be incorporated into current integrated healthcare information technology systems such as the Cerner Millennium® solutions offered by Cerner Corporation of North Kansas City, Mo. Having briefly described an embodiment of the present invention, an exemplary operating environment for the present invention is described below.

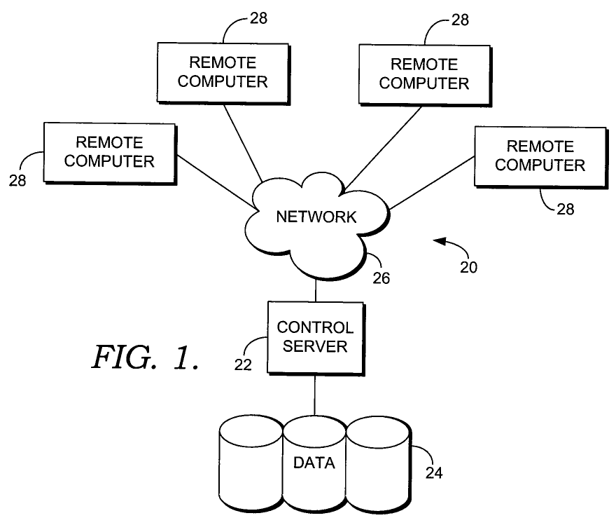

With reference to FIG. 1, an exemplary medical information system for implementing embodiments of the invention includes a general purpose-computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes therein or has access to a variety of computer readable media, for instance, database cluster 24. Computer readable media can be any available media that can be accessed by server 22, and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including database cluster 24, discussed above and illustrated in FIG. 1, provide storage of computer readable instructions, data structures, program modules, and other data for server 22.

Server 22 may operate in a computer network 26 using logical connections to one or more remote computers 28. Remote computers 28 can be located at a variety of locations in a medical or research environment, for example, but not limited to, clinical laboratories, hospitals, other inpatient settings, a clinician's office, ambulatory settings, medical billing and financial offices, hospital administration, veterinary environment and home health care environment. Clinicians include, but are not limited to, the treating physician, specialists such as surgeons, radiologists and cardiologists, emergency medical technologists, discharge planners, care planners, physician's assistants, nurse practitioners, nurses, nurse's aides, pharmacists, dieticians, microbiologists, laboratory experts, laboratory scientist, laboratory technologists, genetic counselors, researchers, veterinarians and the like. The remote computers may also be physically located in non-traditional medical care environments so that the entire health care community is capable of integration on the network. Remote computers 28 may be a personal computer, server, router, a network PC, a peer device, other common network node or the like, and may include some or all of the elements described above relative to server 22. Computer network 26 may be a local area network (LAN) and/or a wide area network (WAN), but may also include other networks. Such networking environments are commonplace in offices, enterprise-wide computer networks, intranets and the Internet. When utilized in a WAN networking environment, server 22 may include a modem or other means for establishing communications over the WAN, such as the Internet. In a networked environment, program modules or portions thereof may be stored in server 22, or database cluster 24, or on any of the remote computers 28. For example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, scanner, or the like. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention. Although the method and system are described as being implemented in a LAN operating system, one skilled in the art would recognize that the method and system can be implemented in any system.

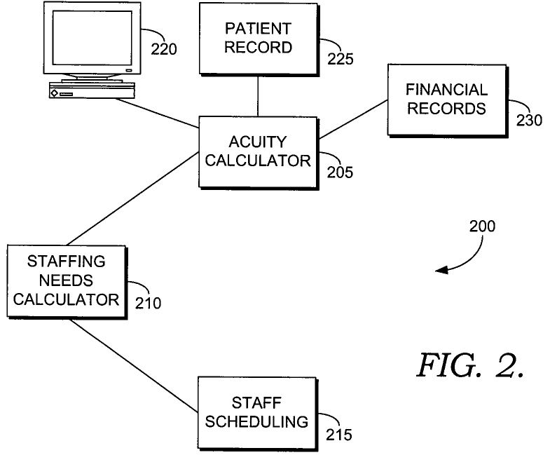

With reference to FIG. 2, an exemplary system 200 is provided. The acuity calculator 205 is in communication with a healthcare information technology system device 220 such as a remote computer(s) 28 of FIG. 1 for receiving inputs via a network or other connection such as network 26 of FIG. 1. The acuity calculator 205, staffing needs calculator 210, and staff scheduling module 215 may reside on control server 22 or may reside elsewhere.

A nurse uses his or her professional judgment to determine and enter a patient's care needs assessment and activities of daily living assessment into the device 220. Unlike previous acuity systems that have significantly more questions and require a large amount of data entry, two items are entered in the acuity system of the present invention based on a nurse's professional judgment. This is less time-consuming for the nurse than entering multiple items. Also, the system is more effective since the nurse is best suited to estimate the amount of work it will take to care for a patient.

Once the patient's care needs assessment level and ADL assessment level are received by the acuity calculator 205, the acuity calculator 205 utilizes the care needs assessment and ADL assessment level for the patient to calculate an acuity level for the patient. The acuity level calculated for the patient by the acuity calculator 205 is communicated to a staffing needs calculator 210 to determine the number of staff members required on a unit based on the acuity levels of patients. The staffing needs calculator 210 is in communication with a staff scheduling module 215 responsible for scheduling healthcare providers according to the needs of a unit.

The acuity calculator 205 is also in communication with patient records 225 and financial records 230. The acuity level calculated by the acuity calculator 205 may be stored in a patient record, such as an electronic medical record, so that it is associated with the patient and may be displayed to clinicians. The acuity level for the patient calculated by the acuity calculator may be communicated to financial records 230 to be leverage for charging the patient, or other responsible parties, such as Medicaid, Medicare or private insurance companies for patient care. In one embodiment, patient records 225 and/or financial records 230 are stored in a data store such as data store 24 of FIG. 1.

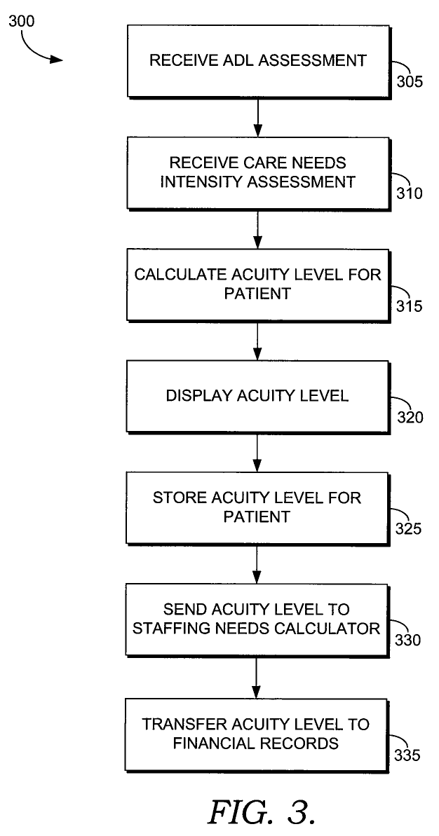

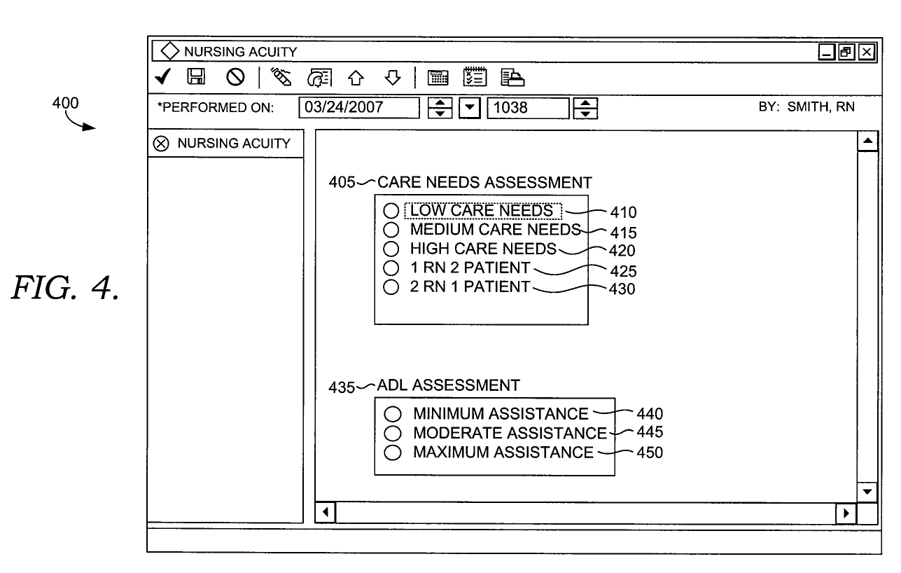

With reference to FIG. 3, a method 300 for calculating an acuity level for a healthcare patient is provided. Initially, at step 305, a representation of a patient's Activities of Daily Living (ADL) assessment, such as an estimation of the amount of assistance a patient requires for performing the necessary activities of daily living, is received. Activities of daily living include items such as drinking, bathing, elimination, personal hygiene, mobility, feeding and dressing. For example, with reference to FIG. 4, a nurse enters a single indication of a patient's ADL dependency 435 by selecting that the patient is classified as needing one of minimum assistance 440, moderate assistance 445 or maximum assistance 450. The patient's ADL is input by a care provider, such as a nurse, using the nurse's professional judgment on how much assistance the nurse thinks the patient will need while admitted to the healthcare facility.

At step 310, the patient's care needs intensity assessment is received. The estimation of the patient's care needs includes an overall assessment of the patient by a nurse taking into account the amount of nursing supervision or intervention, the orientation of the patient, stability of the patient, number and type of medications to be administered, procedures to be performed, nature and quality of psychosocial support needed, education needs and risk for deterioration of condition.

For example, with reference to FIG. 4, a nurse enters a single indication of a patient's care needs intensity assessment 405 by selecting that the a patient has one of low care needs 410, medium care needs 415, or high care needs 420. Furthermore, there may be certain conditions where a ratio of nursing staff is required. For example, one registered nurse may be required for every two patients 425 or two registered nurses may be required for one patient 430. In these instances, since the ratios are mandated, a nurse enters a single indication for the patient's care needs intensity as one nurse for every two patients 425 or two nurses for one patient 430 without entering the patient's ADL dependency level.

To aid a nurse in making the proper care needs determination for the patient a link to a table may be accessed from the screen in FIG. 4. The table may be accessible via a link, by right clicking on the care needs intensity box 405 or any other variety of ways. Once accessed, the care needs assessment table is displayed to the nurse on a graphical user interface.

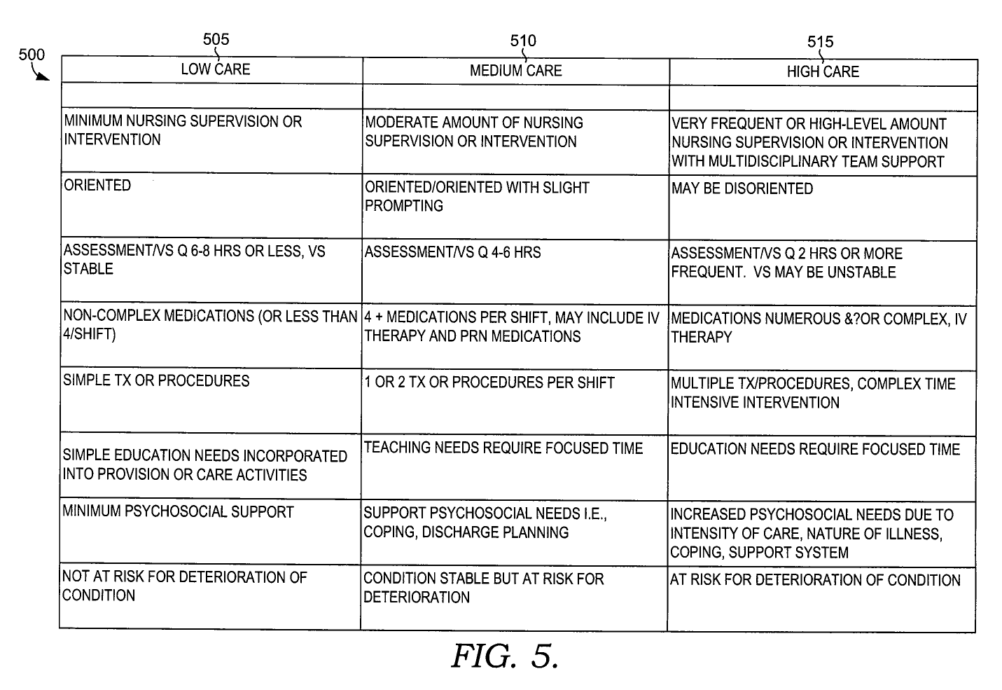

An exemplary care needs assessment table 500 is shown in FIG. 5. The care needs assessment table includes items that would aid a nurse in determining whether the patient has low care needs 505, medium care needs 510 or high care needs 515. The care needs assessment table may be modified based on the unit or type of patient. For example, an orthopedic patient may have different care needs than a cardiology patient.

Once a nurse, using the nurse's professional judgment, has entered a single indication of the patient's care needs intensity and ADL dependency level, at step 315, the acuity level is calculated by the acuity calculator. There are eleven (11) acuity levels described in the embodiment of the present invention, although it will be appreciated that there may be any number of levels. Acuity level one (1) is the lowest level and represents when a nurse has made a single indication that the patient needs minimum ADL assistance and is a low care needs patient. Acuity level two (2) represents the level for a patient where it has been entered into the system that the patient needs moderate ADL assistance and is a low care needs patient. Acuity level three (3) represents the level for a patient where it has been entered into the system that the patient needs maximum ADL assistance and is a low care needs patient. Acuity level four (4) represents the level for a patient where it has been entered into the system that the patient needs minimum ADL assistance and is a medium care needs patient.

Acuity level five (5) represents the level for a patient where it has been entered into the system that the patient needs moderate ADL assistance and is a medium care needs patient. Acuity level six (6) represents the level for a patient where it has been entered into the system that the patient needs maximum ADL assistance and is a medium care needs patient. Acuity level seven (7) represents the level for a patient where it has been entered into the system that the patient needs minimum ADL assistance and is a high care needs patient. Acuity level eight (8) represents the level for a patient where it has been entered into the system that the patient needs moderate ADL assistance and is a high care needs patient. Acuity level nine (9) represents the level for a patient where it has been entered into the system that the patient needs maximum ADL assistance and is a high care needs patient. Acuity level ten (10) represents the level for a patient where it has been entered into the system that the patient needs one registered nurse for every two patients. Activity level eleven (11) represents the level for a patient requiring two nurses to care for patient.

An example of a calculated acuity level based on a single indication of care needs intensity and a single indication of ADL dependency for a patient is a child who is in good health. As the child is in good health and needs minimal nursing supervision, a nurse indicates that the patient is a low care needs patient for care needs intensity. However, the nurse indicates that as this is a pediatric patient, the patient requires maximum assistance for activities of daily living. As such, the pediatric patient would have an acuity level of three (3).

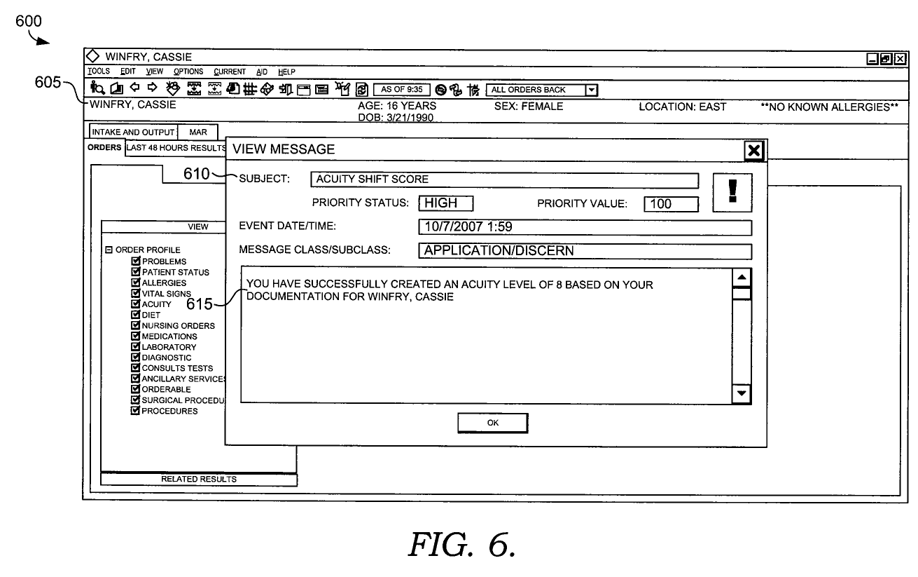

At step 320, the patient's acuity level is displayed. The patient's acuity level may be displayed in a variety of ways. With reference to FIG. 6, a graphical user interface 600 is shown. By way of example, and not by limitation, if a nurse has entered into a computerized system that the patient's estimated care needs are high and the patient's ADL needs are moderate, an acuity level of eight (8) is calculated for the patient 605. The nurse is notified that the calculated acuity level 615 for the patient is eight (8) based on the nurse's documentation of the patient's estimated care needs and patient's ADL dependency.

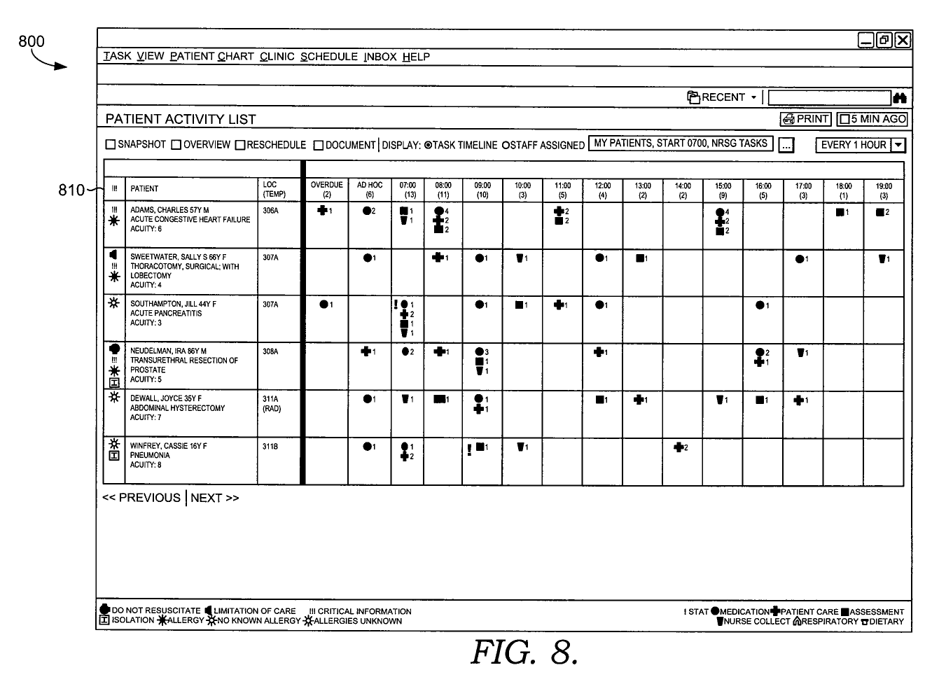

With reference to FIG. 8, the patient's acuity level may also be displayed on a patient activity list 800. The patient activity list is populated with patient names 805 that have been assigned to a given caregiver, such as a nurse, and allows the caregiver to view the various activities and relevant data associated with those patients. For example, the patient activity list 800 in FIG. 8 is provided for an ICU nurse. The patient activity list 800 provides a timeline view showing when patients have care-needed activities due. The patient activity list 800 also provides important information to a caregiver. Among that important information includes the patient's name, age, sex, medical condition and acuity level calculated by the acuity calculator.

The patient activity list includes the acuity levels for patient's assigned to the caregiver. Accordingly, the caregiver has six patients, with acuity level's ranging from 3-8. This allows a caregiver to see in numerical terms, the amount of work that will be required for each patient assigned to the caregiver, and utilize this information to properly balance the caregiver's workload.

Referring again to FIG. 3, at step 325, the acuity level for the patient is stored. The acuity level for the patient may be stored in any variety of database or tables. For example, the acuity level for the patient, along with data regarding the time and date the acuity level was determined and the caregiver responsible for entering the care needs assessment and activities, may be stored in patient records, such as a patient's electronic medical record.

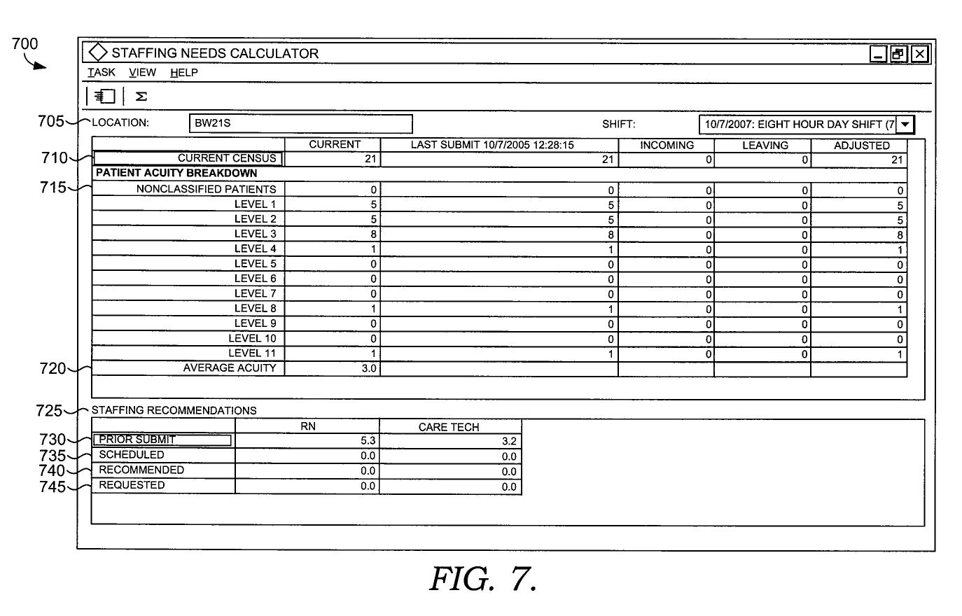

At step 330, the calculated acuity level is sent to a staffing needs calculator. Cerner Corporation of North Kansas City, Mo. offers an exemplary staffing needs calculator. With reference to FIG. 7, an exemplary screen 700 of a staffing needs calculator is shown. The staffing needs calculator is organized by location 705, such as by unit. The current census 710 of patients includes the number of current patients, incoming patients and patients leaving the unit. A patient acuity breakdown is shown and includes the number of nonclassified patients 715 by acuity level. For example, the number of patients having acuity levels of 1-11 is shown. For example, of the twenty-one (21) patients, eight (8) patients have an acuity level of three (3). The average acuity level 720 is also calculated. Furthermore, a staff scheduling module may utilize the data from the staffing needs calculator to schedule staff accordingly. An exemplary staff scheduling module is WORKFORCE MANAGEMENT offered by Cerner Corporation of North Kansas City, Mo.

At step 335, the acuity level is transferred to financial records. The acuity level may be used to determine the charges for care of a patient. For example, a patient with an acuity level of nine (9) may be charged more for hospital care than a patient with a calculated acuity level of two (2).

The present invention has been described in relation to particular embodiments, which are intended in all respects to illustrate rather than restrict. Alternative embodiments will become apparent to those skilled in the art that do not depart from its scope. Many alternative embodiments exist, but are not included because of the nature of this invention. A skilled programmer may develop alternative means for implementing the aforementioned improvements without departing from the scope of the present invention.

It will be understood that certain features and sub-combinations of utility may be employed without reference to features and sub-combinations and are contemplated within the scope of the claims. Furthermore, the steps performed need not be performed in the order described.

The invention claimed is:

1. A computer-readable medium having computer-executable instructions for performing steps to calculate and display an acuity level for a patient, comprising:
receiving a single indication from a user specifying a care needs assessment for a patient;
receiving a single indication from a user specifying an activities of daily living assessment for the patient;
utilizing the care needs assessment indication and the activities of daily living assessment indication to calculate an acuity level for the patient; and
presenting the calculated acuity level for the patient to one or more caregivers.

2. The computer-readable medium of claim 1, wherein the calculated acuity level is presented to the user inputting the care needs assessment and the activities of daily living assessment for the patient.

3. The computer-readable medium of claim 1, wherein the calculated acuity level is presented to the caregiver assigned the patient.

4. The computer-readable medium of claim 1, wherein the care needs assessment refers to the amount of medical nursing supervision or invention needed.

5. The computer-readable medium of claim 1, wherein the activities of daily living assessment refers to amount of help a patient needs with daily living items including drinking, bathing, elimination, personal hygiene, mobility, feeding and dressing.

6. The computer-readable medium of claim 1, wherein the single indication from the user specifying the care needs assessment for a patient includes the selection of an option categorizing the patient as one of low care needs, medium care needs, high care needs, one registered nurse for two patients and two registered nurses for one patient.

7. The computer-readable medium of claim 1, wherein the single indication from the user specifying the activities of daily living assessment for the patient includes the selection of an option categorizing the patient as one of needing minimum assistance, moderate assistance and maximum assistance.

8. The computer-readable medium of claim 1, further comprising instructions for leveraging the calculated acuity level to determine financial costs for treatment of the patient.

9. The computer-readable medium of claim 1, further comprising instructions for utilizing the calculated acuity level for the patient to determine staffing needs.

10. The computer-readable medium of claim 1, further comprising instructions for utilizing the calculated acuity level for the patient to determine staff scheduling.

11. A graphical user interface embodied on a computer-readable medium and executable on a computer, said graphical user interface comprising:
a first display area configured for displaying two or more care needs assessment options for a patient;
a second display area configured for displaying two or more activities of daily living needs assessment options for the patient, wherein a user may select one of the care needs assessment options and one of the activities of daily living needs assessment options to be utilized to calculate an acuity level for a patient.

12. The graphical user interface of claim 11, further comprising:
a third display area configured for displaying a link to a care needs assessment table, wherein the care needs assessment table may be utilized by a caregiver to aid in determining the care need assessment for a patient.

13. The graphical user interface of claim 11, wherein the two or more care needs assessment options include categorizing the patient as one of low care needs, medium care needs, high care needs, one registered nurse for two patients and two registered nurses for one patient.

14. The graphical user interface of claim 11, wherein two or more activities of daily living needs assessment options include categorizing the patient as needing minimum assistance, moderate assistance and maximum assistance.

15. In a computer system having a graphical user interface including a display and a user interface selection device, a method of calculating and presenting an acuity level for a patient, comprising:
receiving a single indication from a user utilizing a user interface selection device specifying a care needs assessment for a patient;
receiving a single indication from a user utilizing a user interface selection device specifying an activities of daily living assessment for the patient;
calculating an acuity level for the patient based on the care needs assessment indication and the activities of daily living assessment indication; and
presenting the calculated acuity level for the patient to one or more caregivers.

16. The computer system of claim 2, wherein the calculated acuity level is presented to the user inputting the care needs assessment and the activities of daily living assessment for the patient.

17. The computer system of claim 15, wherein the calculated acuity level is presented to the caregiver assigned the patient.

18. The computer system of claim 15, wherein the care needs assessment refers to the amount of medical nursing supervision or invention needed.

19. The computer system of claim 15, wherein the activities of daily living assessment refers to amount of help a patient needs with daily living items including drinking, bathing, elimination, personal hygiene, mobility, feeding and dressing.

20. The computer system of claim 15, wherein the single indication from the user specifying the care needs assessment for a patient includes the selection of an option categorizing the patient as one of low care needs, medium care needs, high care needs, one registered nurse for two patients and two registered nurses for one patient.

21. The computer system of claim 15, wherein the single indication from the user specifying the activities of daily living assessment for the patient includes the selection of an option categorizing the patient as one of needing minimum assistance, moderate assistance and maximum assistance.
